(19) United States
(12) Patent Application Publication
(10) Pub. No.: US 2018/0190257 A1
(43) Pub. Date: Jul. 5, 2018

(54) Intelligent Umbrellas and/or Robotic Shading Systems Including Noise Cancellation or Reduction

(71) Applicant: Shadecraft, Inc., Pasadena, CA (US)

(72) Inventor: Armen Sevada Gharabegian, Glendale, CA (US)

(21) Appl. No.: 15/681,377

(22) Filed: Aug. 19, 2017

Related U.S. Application Data
(63) Continuation-in-part of application No. 15/675,674, filed on Aug. 11, 2017.
Application No. 15/675,674 is a continuation-in-part of application No. 15/436,759, filed on Feb. 17, 2017.
Application No. 15/436,759 is a continuation-in-part of application No. 15/418,380, filed on Jan. 27, 2017, now Pat. No. 9,839,267.
Application No. 15/418,380 is a continuation-in-part of application No. 15/394,080, filed on Dec. 29, 2016, now Pat. No. 9,951,541.

(51) Int. Cl. G10K 11/178

(52) U.S. Cl. CPC G10K 11/178; A45B 25/00; A45B 2200/1027

(57) ABSTRACT

An intelligent umbrella, includes a shading expansion assembly, a support assembly, coupled to the shading expansion assembly, to provide support for the shading expansion assembly and a base assembly, coupled to the support assembly, to provide contact with a surface. The intelligent umbrella may further comprise one or more wireless communication transceivers, one or more microphones to capture audible commands, one or more memory modules, one or more processors, and computer-readable instructions stored in the one or more memory modules are executed by a processor to convert the captured audible commands into one or more audio files and perform noise reduction or noise cancellation on the one or more audio files to generate one or more noise-reduced audio files.

### RELATED APPLICATIONS

This application claims priority to and is a continuation-in-part of application Ser. No. 15/675,674, filed Aug. 11, 2017 and entitled “Control of Multiple Intelligent Umbrellas and/or Robotic Shading Systems,” which is a continuation-in-part of patent application Ser. No. 15/436,759, filed Feb. 17, 2017, entitled “Marine Vessel with Intelligent Shading System,” which is a continuation-in-part of patent application Ser. No. 15/418,380, filed Jan. 27, 2017, entitled “Shading System with Artificial Intelligence Application Programming Interface,” which is a continuation-in-part of patent application Ser. No. 15/394,080, filed Dec. 29, 2016, entitled “Modular Umbrella Shading System,” the disclosures of which are hereby incorporated by reference.

### BACKGROUND

Current umbrellas are not adaptable to environmental conditions. Current umbrellas and shading systems require users to manually establish settings. Current umbrellas also require users to move around in order to position the umbrella and/or shading system into different positions. Therefore, a need exists for an umbrella or shading system that can easily change positions and/or settings without requiring a user to move from an existing position and/or to manually move the umbrella and/or shading system.

### BRIEF DESCRIPTION OF THE DRAWINGS

FIG. 1 illustrates a mobile communications device, a third party voice recognition and/or artificial intelligence server, and/or an intelligent umbrella/robotic shading system in a noise-filled environment according to embodiments;

FIG. 2 illustrates a flowchart of an intelligent umbrella noise reduction or cancellation process utilizing a mobile communications device or an intelligent umbrella or robotic shading system according to embodiments;

FIGS. 3A and 3B illustrates impact of a noise reduction or cancellation process on voice command audio files for intelligent umbrellas and/or robotic shading systems according to embodiments;

FIG. 4 illustrates a microphone and/or LED array in an AI device housing according to embodiments;

FIG. 5A illustrates an shading system including an artificial intelligence engine and/or artificial intelligence interface;

FIG. 5B illustrates a block and dataflow diagram of communications between a shading system and/or one or more external AI servers according to embodiments; and

FIG. 6 illustrates an intelligent shading system comprising a shading housing wherein a shading housing comprises an AI or a noise reduction API according to embodiments.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a problem, such as signal processing of signal samples, for example, may be allocated among computing devices, including one or more clients and/or one or more servers, via a computing and/or communications network, for example. A network may comprise two or more computing devices and/or may couple network devices so that signal communications, such as in the form of signal packets and/or frames (e.g., comprising one or more signal samples), for example, may be exchanged, such as between a server and a client device and/or other types of devices, including between wireless devices coupled via a wireless network, for example.

A network may comprise two or more network and/or computing devices and/or may couple network and/or computing devices so that signal communications, such as in the form of signal packets, for example, may be exchanged, such as between a server and a client device and/or other types of devices, including between wireless devices coupled via a wireless network, for example.

In this context, the term computing device refers to any device capable of communicating via and/or as part of a network. While computing devices may be capable of sending and/or receiving signals (e.g., signal packets and/or frames), such as via a wired and/or wireless network, they may also be capable of performing arithmetic and/or logic operations, processing and/or storing signals (e.g., signal samples), such as in memory as physical memory states, and/or may, for example, operate as a server in various embodiments.

Computing devices, mobile computing devices, and/or network devices capable of operating as a server, or otherwise, may include, as examples, rack-mounted servers, desktop computers, laptop computers, set top boxes, tablets, netbooks, smart phones, wearable devices, integrated devices combining two or more features of the foregoing devices, the like or any combination thereof. As mentioned, signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases, database servers, application data servers, proxy servers, and/or portions thereof, as appropriate.

It should be understood that for ease of description a network device may be embodied and/or described in terms of a computing device and/or mobile computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. In a context of this application, if signals, instructions, and/or commands are transmitted from one component (e.g., a controller or processor) to another component (or assembly), it is understood that messages, signals, instructions, and/or commands may be transmitted directly to a component, or may pass through a number of other components on a way to a destination component. For example, a signal transmitted from a motor controller or processor to a motor (or other driving assembly) may pass through glue logic, an amplifier, an analog-to-digital converter, a digital-to-analog converter, another controller and/or processor, and/or an interface. Similarly, a signal communicated through a misting system may pass through an air conditioning and/or a heating module, and a signal communicated from any one or a number of sensors to a controller and/or processor may pass through a conditioning module, an analog-to-digital controller, and/or a comparison module, and/or a number of other electrical assemblies and/or components.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include for example, past, present and/or future mass storage, such as network attached storage (NAS), cloud storage, a storage area network (SAN), cloud storage, cloud server farms, and/or other forms of computing and/or device readable media, for example. A network may include a portion of the Internet, one or more local area networks (LANs), one or more wide area networks (WANs), wire-line type connections, one or more personal area networks (PANs), wireless type connections, one or more mesh networks, one or more cellular communication networks, other connections, or any combination thereof. Thus, a network may be worldwide in scope and/or extent.

The Internet and/or a global communications network may refer to a decentralized global network of interoperable networks that comply with the Internet Protocol (IP). It is noted that there are several versions of the Internet Protocol. Here, the term Internet Protocol, IP, and/or similar terms, is intended to refer to any version, now known and/or later developed of the Internet Protocol. The Internet may include local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices and/or computing devices may engage in an HTTP session through an exchange of appropriately compatible and/or compliant signal packets and/or frames. Here, the term Hypertext Transfer Protocol, HTTP, and/or similar terms is intended to refer to any version, now known and/or later developed. It is likewise noted that in various places in this document substitution of the term Internet with the term World Wide Web (Web′) may be made without a significant departure in meaning and may, therefore, not be inappropriate in that the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. A content delivery server and/or the Internet and/or the Web, therefore, in this context, may comprise an service that organizes stored content, such as, for example, text, images, video, etc., through the use of hypermedia, for example. A HyperText Markup Language (“HTML”), Cascading Style Sheets (“CSS”) or Extensible Markup Language (“XML”), for example, may be utilized to specify content and/or to specify a format for hypermedia type content, such as in the form of a file and/or an “electronic document,” such as a Web page, for example. HTML and/or XML are merely example languages provided as illustrations and intended to refer to any version, now known and/or developed at another time and claimed subject matter is not intended to be limited to examples provided as illustrations, of course.

Also as used herein, one or more parameters may be descriptive of a collection of signal samples, such as one or more electronic documents, and exist in the form of physical signals and/or physical states, such as memory states. For example, one or more parameters, such as referring to an electronic document comprising an image, may include parameters, such as 1) time of day at which an image was captured, latitude and longitude of an image capture device, such as a camera; 2) time and day of when a sensor reading (e.g., humidity, temperature, air quality, UV radiation) was received; and/or 3) operating conditions of one or more motors or other components or assemblies in a modular umbrella shading system. Claimed subject matter is intended to embrace meaningful, descriptive parameters in any format, so long as the one or more parameters comprise physical signals and/or states, which may include, as parameter examples, name of the collection of signals and/or states.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In embodiments, a modular umbrella shading system may comprise a computing device installed within or as part of a modular umbrella system, intelligent umbrella and/or intelligent shading charging system. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, numbers, numerals or the like, and that these are conventional labels. Unless specifically stated otherwise, it is appreciated that throughout this specification discussions utilizing terms such as “processing,” “computing,” “calculating,” “determining” or the like may refer to actions or processes of a specific apparatus, such as a special purpose computer or a similar special purpose electronic computing device (e.g., such as a shading object computing device). In the context of this specification, therefore, a special purpose computer or a similar special purpose electronic computing device (e.g., a modular umbrella computing device) is capable of manipulating or transforming signals (electronic and/or magnetic) in memories (or components thereof), other storage devices, transmission devices sound reproduction devices, and/or display devices.

In an embodiment, a controller and/or a processor typically performs a series of instructions resulting in data manipulation. In an embodiment, a microcontroller or microprocessor may be a compact microcomputer designed to govern the operation of embedded systems in electronic devices, e.g., an intelligent, automated shading object or umbrella, intelligent umbrella, robotic shading systems, and/or shading charging systems, and various other electronic and mechanical devices coupled thereto or installed thereon. Microcontrollers may include processors, microprocessors, and other electronic components. Controller may be a commercially available processor such as an Intel Pentium, Motorola PowerPC, SGI MIPS, Sun UltraSPARC, or Hewlett-Packard PA-RISC processor, but may be any type of application-specific and/or specifically designed processor or controller. In an embodiment, a processor and/or controller may be connected to other system elements, including one or more memory devices, by a bus, a mesh network or other mesh components. Usually, a processor or controller, may execute an operating system which may be, for example, a Windows-based operating system (Microsoft), a MAC OS System X operating system (Apple Computer), one of many Linux-based operating system distributions (e.g., an open source operating system) a Solaris operating system (Sun), a portable electronic device operating system (e.g., mobile phone operating systems), microcomputer operating systems, and/or a UNIX operating systems. Embodiments are not limited to any particular implementation and/or operating system.

The specification may refer to an intelligent umbrella/robotic shading system (or an intelligent shading object or an intelligent umbrella) as an apparatus that provides shade and/or coverage to a user from weather elements such as sun, wind, rain, and/or hail. In embodiments, the intelligent umbrella may be an automated intelligent shading object, automated intelligent umbrella, standalone intelligent umbrella, and/or automated intelligent shading charging system. The robotic shading system may also be referred to as a parasol, intelligent umbrella, sun shade, outdoor shade furniture, sun screen, sun shelter, awning, sun cover, sun marquee, brolly and other similar names, which may all be utilized interchangeably in this application. Shading objects and/or robotic shading systems which also have electric vehicle charging capabilities may also be referred to as intelligent umbrella charging systems. These terms may be utilized interchangeably throughout the specification. The robotic shading systems, shading objects, intelligent umbrellas, umbrellas and/or parasols described herein comprises many novel and non-obvious features, which are described in detail below.

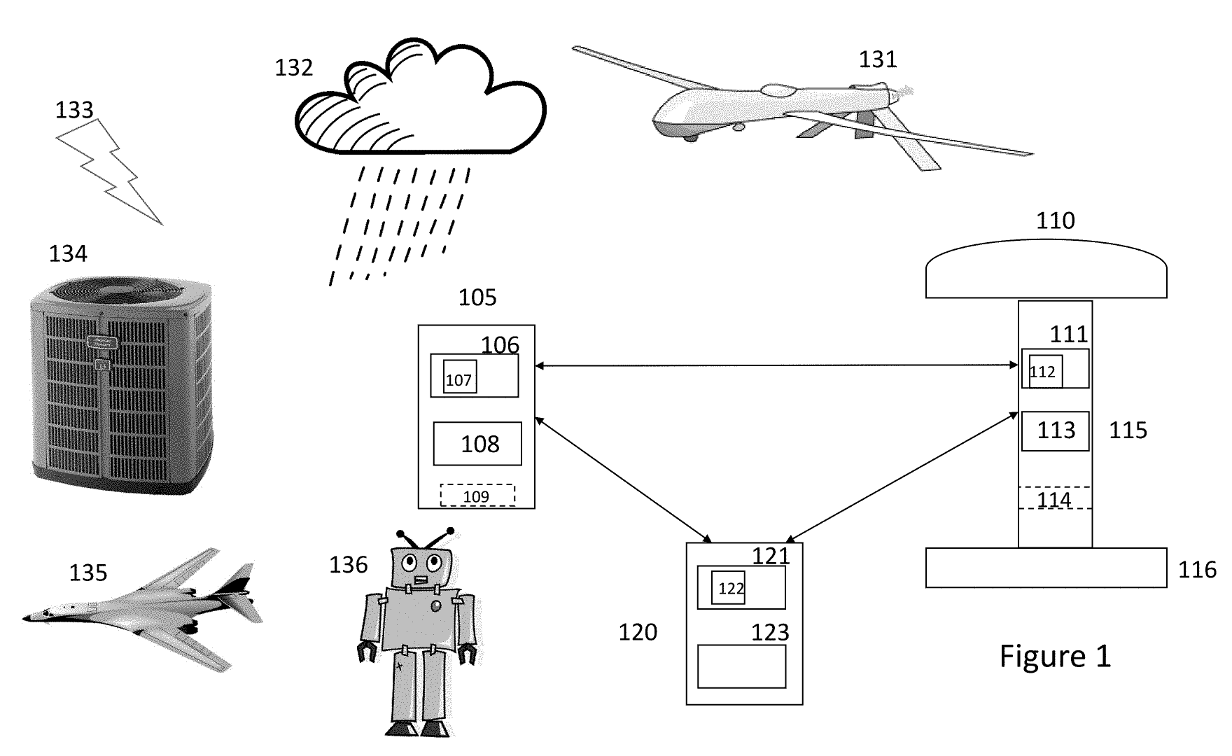

FIG. 1 illustrates a mobile communications device, a third party voice recognition and/or artificial intelligence server, and/or an intelligent umbrella/robotic shading system in a noise-filled environment according to embodiments. In embodiments, a mobile device 105 may comprise one or more processors 108, one or more memory modules 106, one or more microphones 109, and/or computer-readable instructions 107 stored in the one or more memory modules 106 executable by the one or more processors 108. In embodiments, computer-readable instructions 107 executable by a processor may comprise an operation system, driver programs, and/or application programs. In embodiments, computer-readable instructions 107 may comprise voice-recognition software and/or AI software and/or an application programming interface (API) or conduit to voice recognition software and/or AI software executable on another computing device and/or server. In other words, the computer-readable instructions 107 executable by one or more processors 108 of the mobile communications device 105 may be executed on a mobile communications device 105, an intelligent umbrella/robotic shading system 110, a combination of the intelligent umbrella/robotic shading system, a mobile communications device 105 and/or a third party server 120, or mainly a third party server 120. In embodiments, sounds and/or voices may be captured by one or more microphones 109 in a mobile communications device and computer-readable instructions 107 executable by one or more processors 108 may initiate a voice recognition and/or AI software application/process.

In embodiments, an intelligent shading system and/or robotic shading system 110 may comprise a shading element and/or fabric (or an expansion assembly) 117, a support or core assembly 115, and/or a base assembly 116. In embodiments, an intelligent umbrella and/or shading system 110 may comprise one or more processors 113, one or more microphones 114, and/or one or more memory modules 111. In embodiments, computer-readable instructions 112 may be stored in one or more memory modules 111 and may be executable by one or more processors 113. In embodiments, computer-readable instructions 112 may be an umbrella and/or single board computer operating or microcontroller instructions, application programs, mechanical and/or electrical assembly driver, or interface programs. In embodiments, computer-readable instructions 112 may comprise voice-recognition software and/or AI software and/or an application programming interface (API) (or conduit) to voice recognition software and/or AI software executable on another external computing device and/or server. In other words, the computer-readable instructions 112 executable by one or more processors 113 may be resident on an intelligent umbrella/robotic shading system and voice-recognition and/or AI may be performed on the intelligent umbrella 110, a combination of the intelligent umbrella/robotic shading system and/or a third party or external server 120, or mainly a third party or external server 120. In embodiments, a mobile communications device 105 may comprise one or more processors 108, one or more memory modules 106, one or more microphones 109, and/or computer-readable instructions 107. In embodiments, the computer-readable instructions 107 may be executable by the one or more processors 108 to provide noise cancellation, background noise cancellation and/or noise adjustment for users and/or operators of a mobile communications device 105 communicating commands, instructions and/or messages to an intelligent umbrella and/or robotic shading systems 110. In embodiments, sounds and/or voices may be captured by one or more microphones 114 in an intelligent umbrella/robotic shading system 110 and computer-readable instructions 112 executable by one or more processors 113 may initiate a voice recognition and/or AI software application and/or process.

In embodiments, a third party or external server 120 may comprise one or more processors 123 and/or one or more memory modules 121. In embodiments, computer-readable instructions 122 may be stored in one or more memory modules 121 and executable by the one or more processors 123 to perform voice recognition and/or artificial intelligence on voice commands and/or corresponding audio files that were captured by the mobile communications device 105 and/or the intelligent umbrella 110 and communicated from the mobile communications device 105 and/or the intelligent umbrella 110.

In embodiments, however, background noise and/or ambient noise may be present in an environment where intelligent umbrellas and/or robotic shading systems are installed and present and/or are located in a vicinity thereof. When background noise and/or ambient noise is present, voice recognition and/or artificial intelligence becomes more difficult because noise (e.g., ambient or background noise) interferes with accurate capture and/or recognition of voice commands from users and operators. In embodiments, background noise and/or ambient noise may be present due to weather conditions (e.g., lightning 133, rain 132, and/or wind). In embodiments, background noise and/or ambient noise may be present due to transportation noise near an environment where an intelligent umbrella and/or robotic shading system is located or present. In embodiments, transportation noise may be caused and/or generated from a drone 131, aircraft 135, cars, trucks and/or highway noise. In embodiments, background noise and/or ambient noise may be caused or generated by electrical equipment and/or mechanical equipment. In embodiments, for example, equipment generated noise may be generated and/or caused by robots 136, air conditioners 134, sprinkler systems, lawnmowers and/or neighbor stereo systems. Accordingly, in order for voice recognition and/or artificial intelligence software applications (e.g., computer-readable instructions) to operate in an accurate and/or efficient fashion, ambient or background noise may need to be reduced, lowered and/or cancelled by software, hardware and/or a combination thereof. In other words, voice commands (or audible commands) received by a mobile communications device 105 and/or intelligent shading device 110 may be more efficiently, effectively and/or accurately processed after a noise reduction and/or cancellation process is performed either in a mobile communications device 105, an intelligent umbrella and/or shading system 110, and/or a third party or external server 120. Outdoor ambient and background noise are normally not issues inside a structure (e.g., house, hotel or office) because of walls, windows, shades and/or other indoor structures that provide noise protection from weather conditions, transportation noise and/or outdoor equipment noise.

In embodiments, a user and/or operator may utilize a mobile communications device 105 to communicate voice commands, instructions and/or messages to an intelligent umbrella and/or robotic shading system 110. In order words, a user and/or operator may speak into a microphone 109 on a mobile communications device 105, a mobile communications device 105 may capture spoken commands (e.g., audible commands) and may convert the spoken commands into one or more audio files (or audio command files). In embodiments, voice recognition may be performed on the received one or more audio files at either the mobile device 105, the intelligent umbrella and/or robotic shading system 110, and/or a third party voice recognition or AI server 120 in order to identify commands directed to an intelligent umbrella and/or robotic shading system. In embodiments, these commands may be referred to as umbrella commands and/or robotic shading commands. In embodiments, intelligent umbrellas and/or robotic shading systems 110 may be located in outdoor environments and thus noise and/or other sounds may interfere with the umbrella and/or robotic shading voice commands being recognized and/or understood correctly by voice recognition and/or artificial intelligence software (whether executed on a mobile communications device 105, an intelligent umbrella/robotic shading system 110 or voice recognition server 120). In embodiments, the noise may be ambient and/or background noise that is present either periodically, at most times, or sporadically. In embodiments, generation and presence of background and/or ambient noise may be repetitive and predictive due to certain conditions being present under certain conditions, (e.g., at different timeframes, at different days of the week during specific environmental conditions). For example, an intelligent umbrella and/or robotic shading system 110 may be located near an airport, a noise-generating power plant, railroad tracks and/or near a freeway, and thus ambient and/or background noise may be present during operating hours of the airport, power plant, railroad and/or freeway. In embodiments, for example, noise patterns may be similar at these different times of day and/or under specific conditions. For example, when a sprinkler and/or an air conditioner is on, certain noise may regularly be present. Freeways may have similar noise patterns from 6-10 AM in the morning and 3 to 7:30 PM in the evening when heavy traffic flows are present. As discussed, this background and/or ambient noise may cause errors in recognition of umbrella and/or robotic shading commands.

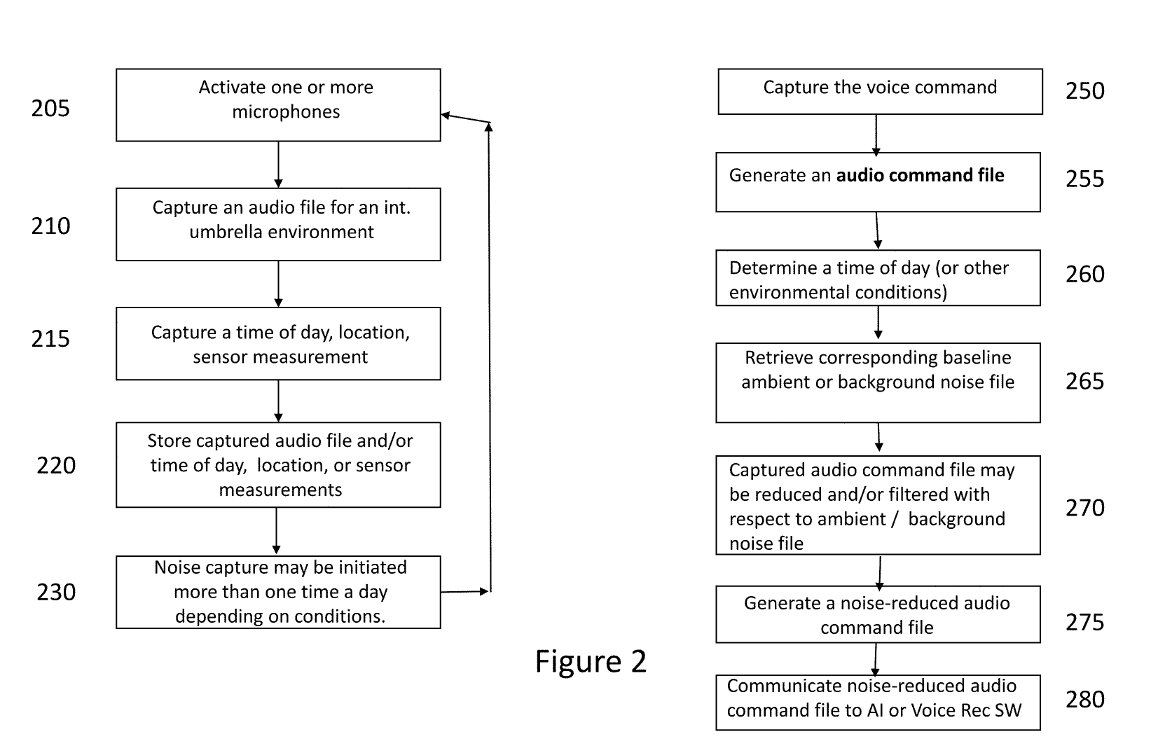

In embodiments, a method and/or process described herein may filter, reduce and/or eliminate background noise in order to improve accuracy of recognition of umbrella and/or robotic shading commands. FIG. 2 illustrates a flowchart of an intelligent umbrella noise reduction or cancellation process utilizing a mobile communications device and/or an intelligent umbrella or robotic shading system according to embodiments. In embodiments, a mobile communications device 105 (e.g., computer-readable instructions executable by one or more processors) may activate 205 one or more microphones. In embodiments, if voice capture is on and/or activated, an intelligent umbrella/automatic shading system 110 may activate one or more microphones. In embodiments, computer-readable instructions executable by one or more processors of a mobile communications device 105 (and/or an intelligent umbrella/automatic/robotic shading system 110) may capture 210 an audio file for an environment surrounding an intelligent umbrella and/or robotic shading system 110 (or in a vicinity of an umbrella/robotic shading system). In embodiments, one or more audio files may be captured for a specified period of time (e.g., 1 minute, 2 minutes or 4 minutes) at a specific time of a day (morning, afternoon and evening or 6:00 am, 1:00 pm or 9:00 pm). In embodiments, times of capture (or days of capture) may be preset and/or pre-established times or may be initiated by a user or operator. In embodiments, in addition to capturing one or more audio files utilizing one or more microphones, computer-readable instructions executable by one or more processors of a mobile computing device (and/or computer-readable instructions executable by one or more processors of an intelligent umbrella/automatic shading system) may also capture 215 a time of day, a geographic location (e.g., from a GPS system), environmental sensor measurements, and/or other measurements. In embodiments, computer-readable instructions may store 220 a captured audio file and/or time of day, geographic location, or environmental sensor measurements in one or more memory modules (e.g., a memory and/or database of a mobile computing device, an intelligent umbrella and/or robotic shading system and/or a remote server) for later utilization in a noise reduction and/or cancellation process. In embodiments, as discussed above, a process described above, may occur automatically at certain times of a day or night without user and/or operator intervention. In embodiments, a noise reduction and/or cancellation capture process may occur: 1) via user input, e.g., selecting an icon to initiate computer-readable instructions to capture ambient noise and background noise audio for a noise cancellation and/or reduction capture process or 2) a user or operator speaking a noise cancellation or reduction initiating (or capture) command and a mobile communications device (and/or an intelligent umbrella/automatic shading system) recognizing and/or responding to such command.

In embodiments, as mentioned above, a noise reduction or cancellation capture process may be initiated 230 more than one time a day. In embodiments, depending on environmental conditions (e.g., different weather patterns (e.g., wind, temperature, etc.) that may be present at different times of a day, a noise cancellation or reduction capture process may occur once in the morning (e.g., 9:00 am), one in the afternoon (e.g., 2:00 pm) and once in the evening. In embodiments, a number of times the noise cancellation or reduction capture process may occur or be initiated to capture background and/or ambient noise may be dependent on intelligent umbrella/robotic shading system usage patterns. For example, if a user or operator mainly utilizes the intelligent umbrella between the hours of 2 pm and 9 pm and the background or ambient noise patterns change in the late afternoon (e.g., 5:30 pm and around 8 pm); then a noise cancellation and/or reduction capture process may be initiated and ambient and/or background noise may be captured around 2 pm; 5:30 pm and around 8 pm) in order to capture and/or monitor background and/or ambient noise during these timeframes. For example, if noise conditions are relatively constant from 9:00 am to 3:00 pm and this is when a user and/or operator may utilize an intelligent umbrella/robotic shading system, a noise cancellation and/or reduction capture process may be initiated once around 9:00 am and background and/or ambient noise may be captured and be representative of an entire timeframe.

After ambient and/or background noise is captured as an audio file and stored in one or more memory modules and/or databases, the captured noise may be utilized as baseline noise for mobile communication device and/or intelligent umbrella and/or robotic shading system voice recognition software and/or artificial intelligence software. In embodiments, one or more baseline ambient and/or background noise audio files may be stored in its entirety. In other words, noise files captured in steps 205 through 230, described above, may be stored as noise audio files in memory modules of mobile communications device, intelligent umbrella/shading system and/or external servers. In embodiments, one or more noise audio files may be sampled in order to generate a plurality of samples of ambient and/or background noise audio files and the plurality of noise samples may be stored in one or more memory modules of a mobile communications device, intelligent umbrella/shading system and/or external servers. In embodiments, for example, a plurality of background and/or ambient noise amplitudes and corresponding frequencies and/or times (e.g., samples of noise files) may be stored in one or more memory modules of mobile communications device 105, intelligent umbrella/shading system 110 and/or external servers 120 and may be utilized for noise reduction and/or cancellation purposes.

In embodiments, as mentioned above, other corresponding measurements may also be stored in one or more memory modules of mobile communications device, intelligent umbrella/shading system and/or external servers, (such as time of audio capture, day of audio capture, one or more sensor readings when audio or audible commands captured, other environmental conditions, etc.), which may be utilized to match or closely correspond to existing conditions when noise cancellation and/or reduction is performed. In other words, computer-readable instructions executable by one or more processors of mobile communications device, intelligent umbrella/shading system and/or external servers may match or attempt to match (e.g., find a closest condition) existing conditions or time frames and retrieve corresponding ambient and background noise audio files and/or samples from the one or more memory modules.

In embodiments, recently captured ambient and/or background noise audio files may be added to existing ambient and/or background noise audio files in order to compile a history of ambient and/or background noise audio files. In embodiments, recently captured ambient and/or background noise files may correspond to a specific time of day, day of the week, and/or other environmental conditions and may be stored with like ambient and/or background noise audio files (e.g., audio files and/or measurements captured at a same time of day and/or same day of week). In other words, database records may include ambient and/or background noise files, corresponding time of days, corresponding days of weeks, and/or measurements (e.g., sensor or umbrella measurements). Also, database records may include a field or flag identifying other like measurements (e.g., time of day, day or week). In embodiments, rather than utilizing a most recently captured ambient and/or background noise audio file, a noise reduction and/or cancellation process may utilize an average of a last few (e.g., three or five) captured ambient and/or background noise audio files as a baseline. In embodiments, a noise reduction and/or cancellation process may average all or nearly all of stored captured ambient and/or background noise audio files as a baseline.

In embodiments, computer-readable instructions executable by one or more processors may also spot and/or identify faulty and/or out-of-tolerance noise readings. In embodiments, this may signal problems with and/or malfunctions of components within a mobile communications device and/or intelligent umbrella/robotic shading system (e.g., such as failure of a microphone and/or components to capture audio files). In embodiments, for example, if computer-readable instructions executable by one or more processors receives a captured ambient and/or background noise signal amplitude reading that is much larger than what is normally been received or measured (e.g., by comparing a recently captured ambient and/or background noise signal to other previously captured ambient and/or background noise signals), then computer-readable instructions executable by one or more processors may generate an error message and/or may request that a mobile communications device and/or intelligent umbrella 1) capture a subsequent ambient and background noise audio file and determine if the subsequent ambient and/or background noise audio file is in tolerance levels or a range of previously collected ambient and/or background noise audio files; and/or 2) perform a diagnostic test on one or more microphones and/or associated circuitry within an intelligent umbrella and/or mobile communications device. In embodiments, computer-readable instructions executable by one or more processors may also request a recalibration process be completed for one or more microphones and/or other associated circuitry within an intelligent umbrella/robotic shading system.

In embodiments, in order to begin operation of voice-command control of an intelligent umbrella and/or robotic shading system, a user or operator may speak a voice command into a mobile phone (and/or an intelligent umbrella/automatic shading system) microphone to instruct and/or request an intelligent umbrella/robotic shading to perform actions related to the command (e.g., such as rotate 30 degrees about a vertical and/or azimuth access). In embodiments, voice commands may be established for activating intelligent umbrella/robotic shading systems lighting systems, image capture devices, computing devices, audio-video receiver and speakers, sensors, azimuth motors, elevation motors, expansion motors, base assembly motors, solar panels, and/or a variety of software applications resident within the intelligent umbrella/robotic shading system and/or third party server (health software applications, point of service software applications, Internet of Thing software applications, energy calculation software applications, video and/or audio storage software applications, etc.). In embodiments, computer-readable instructions executed by a processor may capture the voice command or audible command 250, via one or more microphones, and generate an audio command file 255. In embodiments, computer-readable instructions in a noise reduction process executable by one or more processors may determine and/or calculate 260 a time of day (and/or time of week and/or other environmental conditions) and retrieve 265 corresponding a baseline ambient or background noise audio file (or a sample file) from the one or more memory modules, and/or other corresponding and similarly captured information.

In embodiments, one or more captured audio command files (generated after a user and/or operator speaks a command or audibly speaks a command) may be noise reduced and/or filtered 270 with respect to a corresponding ambient and/or background noise file (e.g., which may have been retrieved from a memory module). In embodiments, one or more ambient or background noise files may be subtracted from one or more audio command files. For example, computer-readable instructions executed by one or more processors may utilize 270 a corresponding ambient and/or background noise file to reduce, cancel and/or eliminate ambient and/or background noise from the captured audio command file. In embodiments, computer-readable instructions executable by one or more processors may generate 275 one or more noise-reduced audio command files that may be utilized in by voice-recognition and/or artificial intelligence applications with a higher degree of accuracy. In embodiments, for example, one or more noise-reduced audio command files may have ambient and/or background noise components (such as wind-generated noise, railroad train noise, freeway or traffic noise, air conditioner noise, and/or neighbor-generated music noise) eliminated, cancelled and/or reduced which allows voice-recognition and/or artificial intelligence software applications to provide more accurate results and generate less errors. In embodiments, computer-readable instructions executed by one or more processors may communicate 280 one or more noise-reduced audio command files as input to a voice-recognition and/or artificial intelligent software application.

In embodiments, noise reduction, elimination and/or cancellation (performed in hardware, software, or a combination thereof) may be performed at a mobile device, an intelligent umbrella and/or robotic shading system, and/or third-party voice recognition server (and/or artificial intelligence server). In embodiments, third-party voice recognition and/or artificial intelligence servers may include Amazon Echo software and servers, Google Now software and servers, Apple Siri software and servers, Microsoft Cortana software and servers, Teneo software and servers or Viv's AI software and servers. Location of noise reduction, elimination and/or cancellation software applications may be dependent on: 1) device and/or server hardware constraints (e.g., processor/controller power; memory; and/or storage (hard drives, solid-state drives, flash memory); 2) communication network constraints (e.g., what wireless and/or wired communication networks and/or transceivers are present in location and whether communication networks have enough bandwidth to handle voice recognition and/or AI applications); and/or 3) user constraints (e.g., does a user and/or operator have a mobile communications device and/or did user purchase an intelligent umbrella/robotic shading system with voice recognition and/or AI functionality).

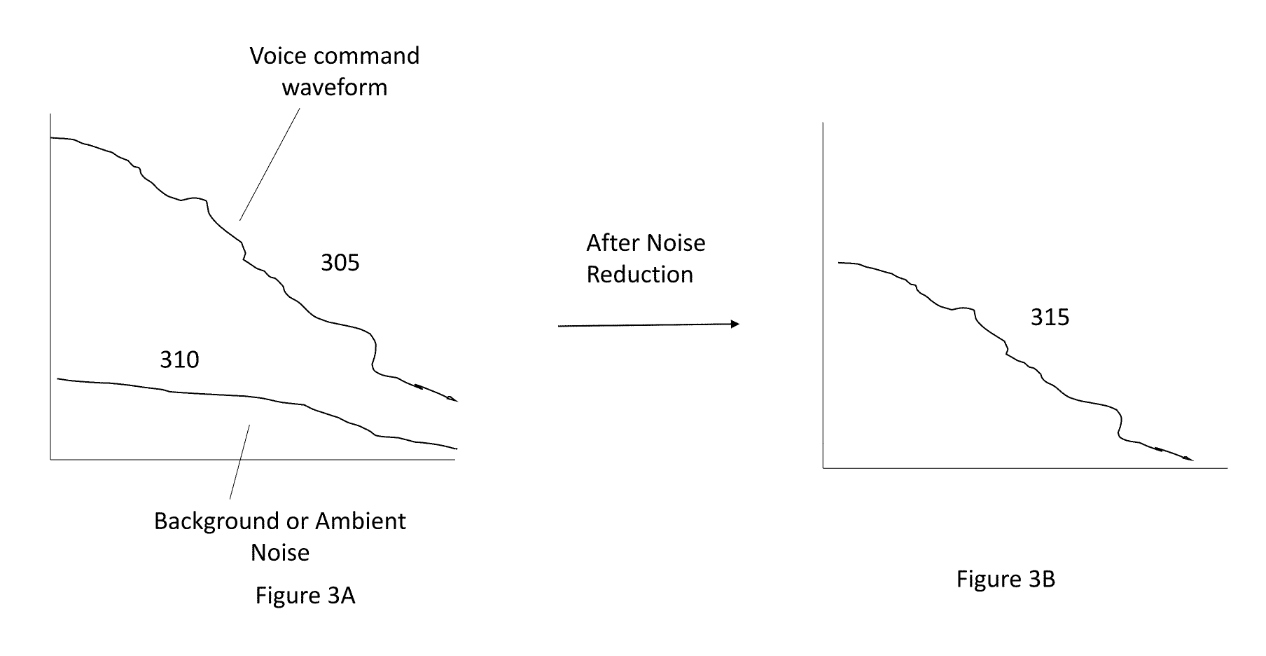

FIGS. 3A and 3B illustrates impact of a noise reduction or cancellation process on voice command audio files for intelligent umbrellas and/or robotic shading systems according to embodiments. FIG. 3A illustrates amplitude 305 of one or more command audio files for specified timeframes as well as amplitude 310 of one or more captured background and/or ambient noise files for specified timeframes. Although not shown, audio files may comprise amplitudes of command audio files at different wavelengths and/or frequencies and corresponding amplitudes of background and/or ambient noise at different wavelengths and/or frequencies may be reduced and/or cancelled during a noise reduction and/or cancellation process. FIG. 3B illustrates an impact of noise reduction or cancellation process on voice command audio files (e.g., amplitudes of voice command audio files). FIG. 3B illustrates an amplitude 320 of a noise-reduced command audio file for specified times according to embodiments. As illustrated by Figure and 3B, amplitude may be reduced for specified timeframes. In addition, it may be that there is a break in a speaker's voice but during this timeframe there was ambient and/or background noise. In this example, a noise-reduction and/or cancellation process may remove and/or eliminate such a noise signal component from a captured audio file because there was no corresponding spoken command during a timeframe. For example, if sprinklers are programmed to turn on at 10:00 am each day and are on for an hour, there will be background noise from the sprinkler system if an intelligent umbrella and/or robotic shading system operator tries to speak voice commands to a cell phone and/or intelligent umbrella during that timeframe. In embodiments, a noise reduction or cancellation process may reduce and/or eliminate noise created by a sprinkler system and be able to provide noise-reduced audio command files that are better analyzed by voice recognition and/or AI software applications.

In embodiments, an intelligent umbrella/robotic shading system may be moved from one location to another. In embodiments, for example, an intelligent umbrella/robotic shading system may be moved from a location where background noise is mainly air conditioners, lawn mowers and/or sprinklers and may move to a different location where background and ambient noise is generated by railroad tracks and freeway noise. In such embodiments, a user and/or operator may recapture background and/or ambient noise for a new embodiment where the intelligent umbrella/robotic shading system has been moved to and re-located. In embodiments, for example, steps 205-230 of FIG. 2 may be repeated for the new environment and/or new location. Similarly, in embodiments, due to changes in seasons (summer versus fall) or conditions (school has started or a holiday season is approaching), different noises may be generated and may need to be accounted for. In embodiments, for example, when summer turns to fall, pool pumps may no longer be heard in environments including intelligent umbrellas and robotic shading systems, whereas leaf blowers and outside heaters may begin to generate noises in the fall. Similarly, when school starts, traffic in certain areas may increase during certain time period and/on certain days.

In embodiments, certain background and/or ambient noises may be stored in a memory modules and/or databases of 1) mobile communication devices, 2) intelligent umbrellas/robotic shading systems and/or 3) voice recognition and/or AI servers may be retrieved automatically and/or by user input. For example, in embodiments, a user and/or operator may not know exact timeframes when ambient and/or background noises may be generated but may know that these noises will likely be present in an environment where an intelligent umbrella and/or robotic shading system may be located. In these circumstances, a user and/or operator may capture such ambient and/or background noises as they occur and store them along with related measurements (time, day and/or conditions) in a database and/or memory modules. In embodiments, for example, ambient and/or background noise audio files may be captured for lawnmower noise, aircraft noise, drone noise, highway noise and/or sprinkler noise. In embodiments, when these noise files are stored, a user or operator may provide a name or type identification for the one or more noise files. Because these ambient and/or background noise files are now stored in memory modules and/or databases of intelligent umbrellas/robotic shading systems, mobile communication devices and/or third party servers, the files may be retrieved when such conditions occur in the environment where the intelligent umbrella and robotic shading system is installed. In embodiments, for example, computer-readable instructions executed by one or more processors may generate an input screen where a user and/or operator can select specific noises which are present in a current environment and thus may need to be cancelled and/or reduced when a user or operator speaks a voice command directed to an action to be performed by an intelligent umbrella and/or robotic shading system. For example, a user could select that sprinkler and/or airplane noise files may need to be retrieved and applied during a noise reduction process to generate noise-reduced audio files. Further, in embodiments, these pre-established noise files (e.g., air conditioner noise, highway noise, aircraft noise) may also have an associated name, a user and/or operator (before speaking a voice command) may speak an associated noise file name (or names) and the identified noise file (or noise files) may be retrieved from one or more memory modules to reduce and/or cancel ambient and background noise from voice commands or audible commands later received by the intelligent umbrella and/or robotic shading system. In embodiments, for example, a user may speak “sprinkler” and/or “aircraft” to retrieve corresponding ambient and/or background noise files and then speak “activate lighting assembly and cameras.” In this illustrative example, sprinkler and/or aircraft ambient and/or background noise may be removed from the received “activate lighting assembly and cameras” captured audio file.

In embodiments, noise reduction, elimination and/or cancellation (performed in hardware, software, or a combination thereof) may be performed with respect to voice commands for intelligent umbrellas and/or robotic shading system, such as intelligent umbrellas, modular umbrella shading systems and shading systems as described in U.S. patent application Ser. No. 15/394,080, filed Dec. 29, 2016, and entitled “Modular Umbrella Shading System.” In embodiments, a noise reduction, elimination and/or cancellation process may be implemented and/or utilized with respect to Artificial Intelligence devices with Shading Systems as described in U.S. patent application Ser. No. 15/418,380, filed Jan. 27, 2016 and entitled “Shading System with Artificial Intelligence Application Programming Interface.” In embodiments, a noise reduction, elimination and/or cancellation process may be implemented in and/or utilized with respect to marine vessel intelligent umbrellas and/or shading systems, as described in U.S. patent application Ser. No. 15/436,739, filed Feb. 17, 2017 and entitled “Marine Vessel with Intelligent Shading Systems.”

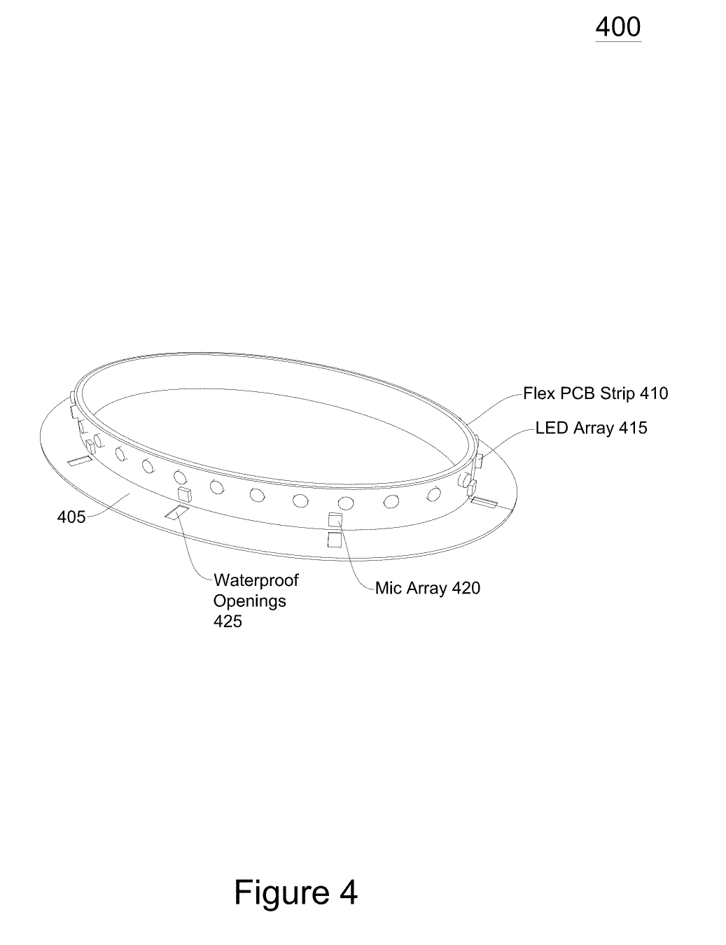

FIG. 4 illustrates a microphone and/or LED array in an AI device housing according to embodiments. In embodiments, a microphone and/or LED array 400 may comprise a plastic housing 405, one or more flexible printed circuit boards (PCBs) or circuit assemblies 410, one or more LEDs or LED arrays 415 and/or one or more microphones and/or microphone arrays 420. In embodiments, a plastic housing 405 may be oval or circular in shape. In embodiments, a plastic housing 405 may be fitted around a shaft, a post and/or tube of for example, a support assembly, 115 in an intelligent umbrella and/or robotic shading system 110. In embodiments, a plastic housing 405 may be adhered to, connected to and/or fastened to a shaft, a post and/or tube. In embodiments, a flexible PCB or housing 410 may be utilized to mount and/or connect electrical components and/or assemblies such as LEDs 415 and/or microphones 420. In embodiments, a flexible PCB or housing 410 may be mounted, adhered or connected to a plastic housing or ring 405. In embodiments, a flexible PCB or housing 410 may be mounted, adhered or connected to an outer surface of a plastic housing or ring 405. In embodiments, a plastic housing or ring 405 may have one or more waterproof openings 425 for venting heat from one or more microphone arrays 420 and/or one or more LED arrays 415. In embodiments, a plastic housing or ring 405 may have one or more waterproof openings for keeping water away and/or protecting one or more microphone arrays 420 and/or one or more LED arrays 415 from moisture and/or water. In embodiments, one or LED arrays 415 may be mounted and/or connected on an outer surface of a flexible PCB strip 410 and may be positioned at various locations on the flexible PCB 410 to provide lighting in areas surrounding a shading and AI system. In embodiments, one or more LED arrays may be spaced at uniform distances around a plastic housing 405 (e.g., or ring housing). In embodiments, one or more microphones or microphone arrays 420 may be mounted and/or connected to a flexible PCB strip 410. In embodiments, one or more microphones or microphone arrays 420 may be positioned at one or more locations around a housing or ring 405 to be able capture audible sound and/or voice commands coming from a variety of directions. In embodiments, one or more microphones or microphone arrays 420 may be spaced at set and/or uniform distances around a housing and/or ring 405.

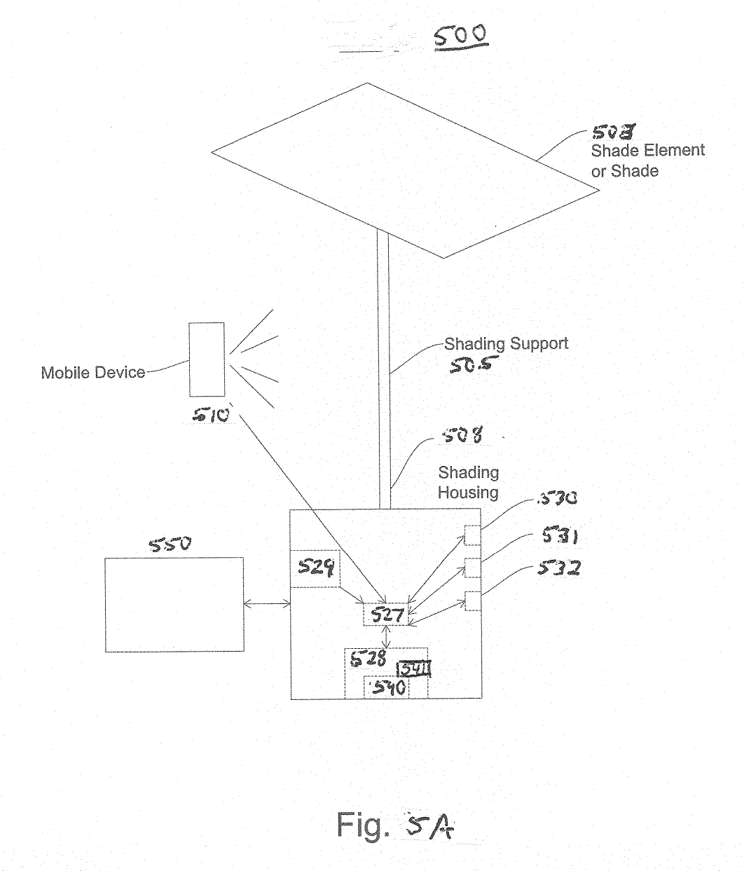

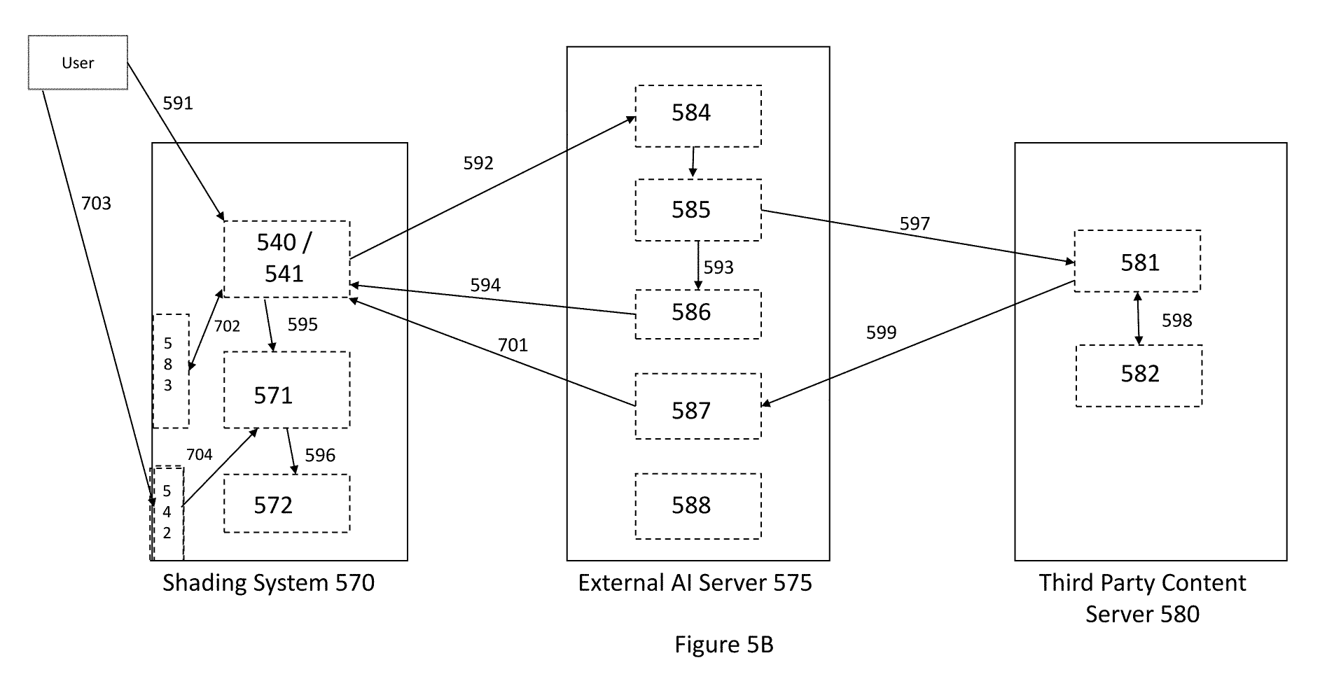

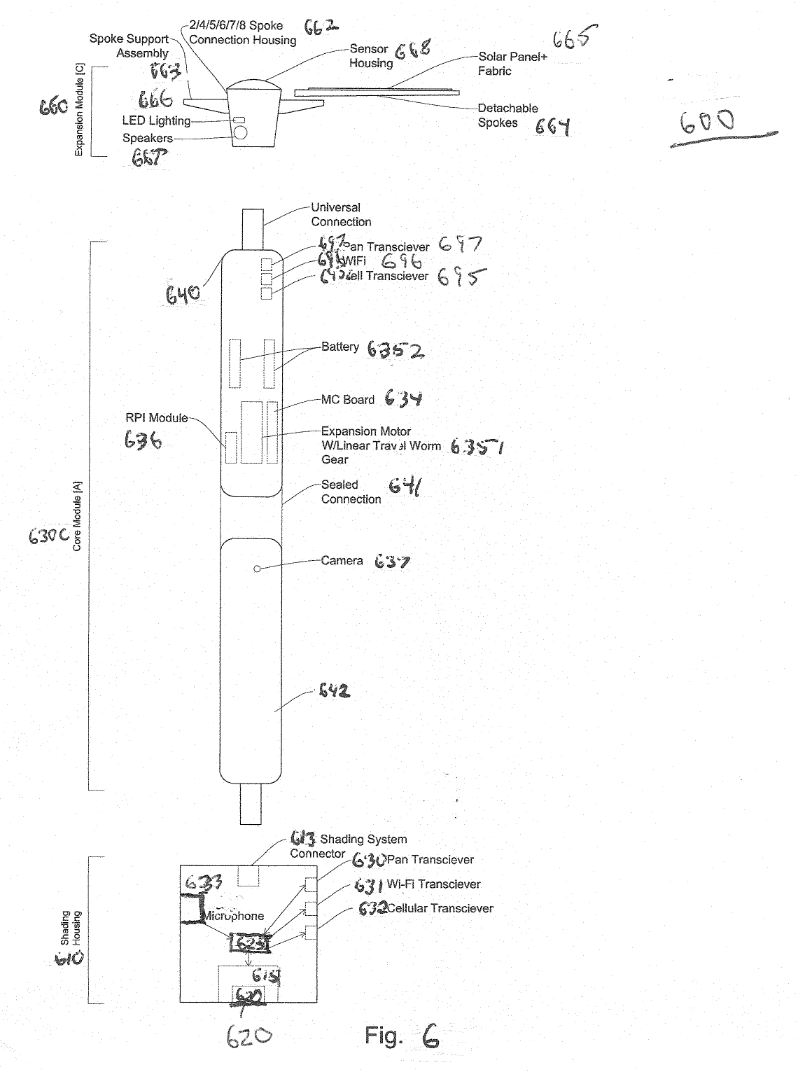

FIG. 5A illustrates a shading system including an artificial intelligence engine and/or artificial intelligence interface. A shading system including artificial intelligence (AI) 500 include a shading element or shade (or an expansion assembly/arm expansion assembly) 503, a shading support 505 and a shading device housing 508. In embodiments, a shading element or shade (or an expansion assembly/arm expansion assembly) 503 may provide shade to keep a shading device housing 508 from overheating. In embodiments, a shading element or shade 503 (or an expansion assembly/arm expansion assembly) may include a shading fabric. In embodiments, a shading device housing 508 may be coupled and/or connected to a shading support 505. In embodiments, a shading support 505 may be coupled to a shading device housing 508. In embodiments, a shading support 505 may support a shade or shading element 503 (or an expansion assembly/arm expansion assembly) and move it into position with respect to a shading device housing 508. In this illustrative embodiment of FIG. 5A, a shading device housing 508 may be utilized as a base, mount and/or support for a shading element or shade 503. In embodiments, a shading support may be simplified and may not have a tilting assembly (as in FIG. 6 described below where an upper housing of a core module assembly 630C is rotated about (or moved about) a lower housing of a core module assembly 630C). In embodiments, a shading support may be simplified and not have a core assembly. In embodiments, a shading support 505 may also not include an expansion and sensor assembly (as is shown in FIG. 6). Illustratively, in embodiments, a shading support/support assembly 505 may not comprise an integrated computing device and/or may not have sensors. In embodiments, a shading element or shade (or an expansion assembly/arm expansion assembly) 503 or a shade support/support assembly 505 may comprise one or more sensors (e.g., environmental sensors). For example, in embodiments, sensors may be a temperature sensor, a wind sensor, a humidity sensor, an air quality sensor, and/or an ultraviolet radiation sensor. In embodiments, a shading support may not include an audio system (e.g., a speaker and/or an audio/video transceiver) and may not include lighting assemblies. In embodiments, a shading housing 508 may not include one or more lighting assemblies.

In embodiments, a shading device housing 508 may comprise a computing device 520. In embodiments, a shading device housing 508 may comprise one or more processors/controllers 527, one or more memory modules 528, one or more microphones (or audio receiving devices) 529, one or more PAN transceivers 530 (e.g., Bluetooth transceivers), one or more wireless transceivers 531 (e.g., WiFi or other 802.11 transceivers), and/or one or more cellular transceivers 532 (e.g., EDGE transceiver, 4G, 3G, CDMA and/or GSM transceivers). In embodiments, the processors, memory, transceivers and/or microphones may be integrated into a computing device 520, where in other embodiments, a single-board computing device may not be utilized. In embodiments, one or more memory modules 528 may contain computer-readable instructions, the computer-readable instructions being executed by one or more processors/controllers 527 to perform certain functionality. In embodiments, the computer-readable instructions stored in one or more memory modules 528 may comprise an artificial intelligence API 540. In embodiments, computer-readable instructions stored in one or more memory modules 528 may comprise a noise cancellation and/or reduction software application 541 and/or application programming interface 541. In embodiments, noise cancellation and/or reduction computer-readable instructions 541 may be executed by processors/controllers 527 in a shading device housing 508. In embodiments, an artificial intelligence API 540 may allow communications between a shading device housing 508 and a third party artificial intelligence engine housed in a local and/or remote server and/or computing device 550. In embodiments, a noise cancellation and/or reduction API 541 may allow communications between a shading device housing 508 and a third party noise cancellation engine housed in a local and/or remote server and/or computing device 550. In embodiments, an AI API 540 may be a voice recognition AI API, which may be able to communicate sound files (e.g., analog or digital sound files) to a third party voice recognition AI server (e.g., server 550). In embodiments, a voice recognition and/or AI server may be an Amazon Alexa, Echo, Echo Dot and/or a Google Now server, which each include AI computer-readable instructions executable by one or more processors. In embodiments, a shading device housing 508 may comprise one or more microphones 529 to capture audio (and specifically) audible and/or voice commands spoken by users and/or operators of shading systems 500. In embodiments, one or more microphones may also be present and/or installed in a mobile communications device 510 to capture audio, and or audible and voice commands spoken by users and/or operators of shading systems. The process of a mobile communications device 510 capturing spoken audible audio and/or voice commands is described above in the discussion of FIG. 1. In embodiments, computer-readable instructions executed by one or more processors 527 may receive captured sounds and create analog and/or digital audio files corresponding to spoken audio commands (e.g., voice commands such as “open shading system,” “rotate shading system,” “elevate shading system,” “select music to play on shading system,” “turn one lighting assemblies,” etc.). In embodiments, a noise reduction or cancellation API 541 may communicate audio files to an external AI and/or voice recognition server 550, which may perform noise reduction or cancellation on the communicated audio files (e.g., corresponding to the spoken commands). In embodiments, if noise reduction or cancellation is performed at the device housing 508 with shading system, noise reduction or cancellation computer-readable instructions 541 executable by one or more processors may cancel and/or reduce noise from the received audio files, and thus may generate noise-reduced audio files (corresponding to spoken commands or audible commands). In embodiments, computer-readable instructions executable by the one or more processors 527 of the shading housing 508 may perform voice recognition and/or AI, whereas in other embodiments, noise-reduced audio files may be communicated to an external voice recognition or AI server for processing at the external voice recognition or AI server 550. In embodiments, an AI API 540 may communicate audio files to an external AI server 550. In embodiments, a shading device housing 508 may communicate generated audio files to external AI servers 550 via or utilizing one or more PAN transceivers 530, one or more wireless local area network transceivers 531, and/or one or more cellular transceivers 532. In other words, communications with an external AI server 550 may occur utilizing PAN transceivers 530 (and protocols). Alternatively, communications with an external AI server 550 may occur utilizing a local area network (802.11 or WiFi) transceiver 531. Alternatively, or in combination with, communications with an external AI server 550 may occur utilizing a cellular transceiver 532 (e.g., utilizing 3G and/or 4G or other cellular communication protocols). In embodiments, a shading device housing 508 may utilize more than one microphones 529 to allow capture of voice commands from a number of locations and/or orientations with respect to a shading system 500 (e.g., in front of, behind a shading system, and/or at a 45 degree angle with respect to a support assembly 505).

FIG. 5B illustrates a block and dataflow diagram of communications between a shading system and/or one or more external AI servers according to embodiments. A shading system 570 may communicate with an external AI server 575 and/or additional content servers 580 via wireless and/or wired communications networks. In embodiments, a user may speak 591 a command (e.g., turn on lights, or rotate shading system) which is captured as an audio file and received. In embodiments, an AI API 540 may communicate and/or transfer 592 an audio file (utilizing a transceiver—PAN, WiFi/802.11, or cellular) to an external or third-party AI server 575. In embodiments, an external or third-party AI server 575 may comprise a noise reduction or cancellation engine or module 584. In embodiments, an external AI server 575 may comprise a voice recognition engine or module 585, a command engine module 586, a third party content interface 587 and/or third party content formatter 588. In embodiments, an external AI server 575 may receive 592 one or more audio files, a noise reduction or cancellation engine or module 584 may receive the communicated audio file, reduce ambient and/or background noise in the communicated audio file and generate one or more noise-reduced audio files. In embodiments, a voice recognition engine or module 585 may convert one or more noise-reduced audio files to a device command (e.g., shading system commands, computing device commands) and communicate 593 device commands to a command engine module or engine 586. In embodiments, if a voice command is for operation of a shading system 500, a command engine or module 586 may communicate and/or transfer 594 a generated command, message, and/or instruction to a shading system 500. In embodiments, a shading system 500 may receive the communicated command, communicate and/or transfer 595 the communicated command to a controller/processor 571. In embodiments, the controller/processor 571 may generate 596 a command, message, signal and/or instruction to cause an assembly, component, system or devices 572 to perform an action requested in the original voice command (open or close shade element, turn on camera, activate solar panels).

In embodiments, a user may request actions to be performed utilizing a shading system's microphones and/or transceivers that may require interfacing with third party content servers (e.g., NEST, e-commerce site selling sun care products, e-commerce site selling parts of umbrellas or shading systems, communicating with online digital music stores (e.g., iTunes), home security servers, weather servers and/or traffic servers). For example, in embodiments, a shading system user may request 1) traffic conditions from a third party traffic server; 2) playing of a playlist from a user's digital music store accounts; 3) ordering a replacement skin and/or spokes/blades arms for a shading system. In these embodiments, additional elements and steps may be added to previously described method and/or process.

For example, in embodiments, a user may speak 591 a command or desired action (execute playlist, order replacement spokes/blades, and/or obtain traffic conditions from a traffic server) which is captured as an audio file and received at an AI API 540 stored in one or more memories of a shading system housing 570. As discussed above, in embodiments, an AI API 540 may communicate and/or transfer 592 an audio file utilizing a shading system's transceiver to an external AI server 575. In embodiments, an external AI server 575 may receive one or more audio files and a noise reduction or cancellation engine or module 585 may receive the communicated one or more audio files, may reduce and/or cancel ambient and/or background noise from the received audio files, and may generate one or more noise-reduced audio files. In embodiments, a voice recognition engine or module 585 may convert 593 the received one or more noise-reduced audio files to a query request (e.g., traffic condition request, e-commerce order, and/or retrieve and stream digital music playlist).

In embodiments, an external AI server may communicate and/or transfer 597 a query request to a third party server (e.g., traffic conditions server (e.g., SIGALERT or Maze), an e-commerce server (e.g., a RITE-AID or SHADECRAFT SERVER, or Apple iTunes SERVER) to obtain third party goods and/or services. In embodiments, a third party content server 580 (a communication and query engine or module 581) may retrieve 598 services from a database 582. In embodiments, a third party content server 580 may communicate services queried by the user (e.g., traffic conditions or digital music files to be streamed) 599 to an external AI server 575. In embodiments, a third party content server 580 may order requested goods for a user and then retrieve and communicate 599 a transaction status to an external AI server 575. In embodiments, a content communication module 587 may receive communicated services (e.g., traffic conditions or streamed digital music files) or transaction status updates (e.g., e-commerce receipts) and may communicate 701 the requested services (e.g., traffic conditions or streamed digital music files) or the transaction status updates to a shading system 570. Traffic services may be converted to an audio signal, and an audio signal may be reproduced utilizing an audio system 583. In embodiments, for example, digital music files may be communicated and/or streamed 702 directed to an audio system 583 because there is no conversion necessary. In embodiments, for example, E-commerce receipts may be converted and communicated to speaker 583 for reading aloud. E-commerce receipts may also be transferred to computing device in a shading system 570 for storage and utilization later.

In embodiments, computer-readable instructions in a memory module of a shading system may be executed by a processor and may comprise a voice recognition module or engine and/or a noise reduction and/or cancellation module or engine 541. In this embodiment, noise reduction and/or cancellation and/or voice recognition may be performed at an intelligent shading system 500 without utilizing a cloud-based server. Similarly, a mobile communications device (510 in FIG. 1) may include computer-readable instructions executable by one or more processors to perform noise reduction or cancellation and/or voice recognition on received audio files captured from microphones. Similarly, in embodiments, a shading system 570 may receive 703 the communicated command, communicate and/or transfer 704 the communicated command to a controller/processor 571. In embodiments, the controller/processor 571 may generate and/or communicate 596 a command, message, signal and/or instruction to cause an assembly, component, system or device 572 to perform an action requested in the original voice command

Referring back to FIG. 5A, in embodiments, a mobile computing device 510 may communicate with a shading system with an artificial intelligence capabilities. In embodiments, a user may communicate with a mobile computing or communications device 510 by a spoken command into a microphone. In embodiments, a mobile computing or communications device 510 may communicate a digital or analog audio file to a processor 527 and/or AI API 540 in a shading device housing. In embodiments, a mobile computing or communications device 510 may also convert the audio file into a textual file for easier conversion from an external or integrated AI server or computing device 550.

FIGS. 5A and 5B describe a shading system having a shading element or shade, shading support and/or shading housing. A shading housing such as the one described above may be attached to any shading system and may provide artificial intelligence functionality and services. In embodiments, a shading system may be an autonomous and/or automated shading system having an integrated computing device, sensors and other components and/or assemblies, and may have artificial intelligence functionality and services provided utilizing an AI API stored in a memory of a shading housing.

FIG. 6 illustrates an intelligent shading system comprising a shading housing wherein a shading housing comprises an AI or a noise reduction API according to embodiments. In embodiments, a shading system 600 comprises an expansion module 660, a core module 630C and a shading housing 610. In embodiments, an expansion module 660 may comprise one or more spoke support assemblies 663, one or more detachable arms/spokes 664, one or more solar panels and/or fabric 665, one or more LED lighting assemblies 666 and/or one or more speakers 667. In embodiments, an expansion module 660 may be coupled and/or connected to a core assembly module 630C. In embodiments, a coupling and/or connection may be made via a universal connection. In embodiments, a core module assembly 630C may comprise an upper assembly 640, a sealed connection 641 and/or a lower assembly 642. In embodiments, a core module assembly 630C may comprise one or more rechargeable batteries 6352, a motion control board 634, an expansion motor 6351 and/or an integrated computing device 636. In embodiments, a core module assembly 630C may comprise one or more transceivers (e.g., a PAN transceiver 630, a WiFi transceiver 631 and/or a cellular transceiver 632). In embodiments, a core module assembly 630C may be coupled and/or connected to a shading housing 610. In embodiments, a universal connector may be a connector and/or coupler between a core module assembly 630C and a shading housing 610.

In embodiments, a shading housing 610 may comprise a shading system connector 613, one or more memory modules 615, one or more processors/controllers 625, one or more microphones 633, one or more transceivers (e.g., a PAN transceiver 630, a wireless local area network (e.g., WiFi) transceiver 631, and/or a cellular transceiver 632), and an artificial intelligence (“AI”) Application programming interface (“API”) or noise reduction or noise cancellation API 620. In embodiments, one or more microphones 633 receives a spoken command and captures/converts the command into a digital and/or analog audio file. In embodiments, one or more processors/controllers 625 interacts and executes AI and/or nose reduction or cancellation API 620 instructions (stored in one or more memory modules 615) and communicates and/or transfers audio files to a third party AI server (e.g., an external AI server or computing device for the external AI or third party server to perform noise reduction or cancellation, voice recognition or AI features). In embodiments, an AI API 620 may communicate and/or transfer audio files via and/or utilizing a PAN transceiver 630, a local area network (e.g., WiFi) transceiver 631, and/or a cellular transceiver 632. In embodiment, in addition, an AI API 620 may receive communications, data, measurements, commands, instructions and/or files from an external AI or third-party server or computing device (as described in FIG. 5A, 5B or 6) and perform and/or execute actions in responses to these communications. In embodiments, alternatively, an intelligent umbrella or shading system 600 may include computer-readable instructions stored in one or more memory modules 615 executable on one or more processors 625 may perform noise reduction and/or cancellation on received audio files as well as performing voice recognition or received audio files or noise-reduced audio files and may communicate the voice-recognized commands and/or the noise-reduced audio files through an AI API 620 to a third-party and/or external AI server. Although, memories and processors are shown in a shading housing 610, in addition, computer-readable instructions, one or more memory modules and/or one or more processors may also be located in a core module 630C and/or an expansion shading assembly or module 660.

In embodiments, a shading system and/or umbrella may communicate via one or more transceivers. This provides a shading system with an ability to communicate with external computing devices, servers and/or mobile communications device in almost any situation. In embodiments, a shading system with a plurality of transceivers (e.g., a PAN transceiver 630, a local area network (e.g., WiFi) transceiver 631, and/or a cellular transceiver 632) may communicate when one or more communication networks are down, experiencing technical difficulties, inoperable and/or not available. For example, a WiFi wireless router may be malfunctioning and a shading system with a plurality of transceivers may be able to communicate with external devices via a PAN transceiver 630 and/or a cellular transceiver 632. In addition, an area may be experiencing heavy rains or weather conditions and cellular communications may be down and/or not available (and thus cellular transceivers 632 may be inoperable). In these situations, a shading system with one or more transceivers may communicate with external computing devices via the operating transceivers. Since most shading systems may not have any communication transceivers, the shading systems described herein is an improvement over existing shading systems that have no communication capabilities and/or limited communication capabilities.

In embodiments, a base assembly or module may also a base motor controller PCB, a base motor, a drive assembly and/or wheels. In embodiments, a base assembly may move to track movement of the sun, wind conditions, and/or an individual's commands. In embodiments, a shading object movement control PCB may send commands, instructions, and/or signals to a base assembly identifying desired movements of a base assembly. In embodiments, a shading computing device system (including a SMARTSHADE and/or SHADECRAFT application) or a desktop computer application may transmit commands, instructions, and/or signals to a base assembly identifying desired movements of a base assembly. In embodiments, a base motor controller PCB may receive commands, instructions, and/or signals and may communicate commands and/or signals to a base motor. In embodiments, a base motor may receive commands and/or signals, which may result in rotation of a motor shaft. In embodiments, a motor shaft may be connected, coupled, or indirectly coupled (through gearing assemblies or other similar assemblies) to one or more drive assemblies. In embodiments, a drive assembly may be one or more axles, where one or more axles may be connected to wheels. In embodiments, for example, a base assembly may receive commands, instructions and/or signal to rotate in a counterclockwise direction approximately 15 degrees. In embodiments, for example, a motor output shaft would rotate one or more drive assemblies rotate a base assembly approximately 15 degrees. In embodiments, a base assembly may comprise more than one motor and/or more than one drive assembly. In this illustrative embodiment, each of motors may be controlled independently from one another and may result in a wider range or movements and more complex movements.

In embodiments, a base assembly 110 and/or first extension assembly 120 may be comprised of stainless steel. In embodiments, a base assembly 110 and/or first extension assembly 120 may be comprised of a plastic and/or a composite material, or a combination of materials listed above. In embodiments, a base assembly 110 and/or first extension assembly 120 may be comprised and/or constructed by a biodegradable material. In embodiments, a base assembly 110 and/or first extension assembly 120 may be tubular with a hollow inside except for shelves, ledges, and/or supporting assemblies. In embodiments, a base assembly 110 and/or first extension assembly 120 may have a coated inside surface. In embodiments, a base assembly 110 and/or first extension assembly 120 may have a circular circumference or a square circumference.

In embodiments, a core module assembly 630C may be comprised of stainless steel. In embodiments, a core module assembly 630C may be comprised of a metal, plastic and/or a composite material, or a combination thereof. In embodiments, a core module assembly 630C may be comprised of wood, steel, aluminum or fiberglass. In embodiments, a shading object center support assembly may be a tubular structure, e.g., may have a circular or an oval circumference. In embodiments, a core module assembly 630C may be a rectangular or triangular structure with a hollow interior. In embodiments, a hollow interior of a core module assembly 630C may have a shelf or other structures for holding or attaching assemblies, PCBs, and/or electrical and/or mechanical components. In embodiments, for example components, PCBs, and/or motors may be attached or connected to an interior wall of a shading object center assembly.

In embodiments, a plurality of spokes/arms/blades 664 and/or spoke/arm support assemblies 663 may be composed of materials such as plastics, plastic composites, fabric, metals, woods, composites, or any combination thereof. In an example embodiment, spokes/arms/blades 664 and/or spoke/arm support assemblies 663 may be made of a flexible material. In an alternative example embodiment, spokes/arms/blades 664 and/or spokes/arm support assemblies 663 may be made of a stiffer material.

Some discussions may be focused on single shading objects, intelligent umbrellas, and/or intelligent shading charging systems. However, descriptions included herein may be applicable to multiple shading objects, intelligent umbrellas and/or intelligent shading charging systems. In addition, while discussions may be directed to a software application or process executing on a computing device of a shading object, intelligent umbrella and/or intelligent shading charging system and controlling one shading object, intelligent umbrella and/or intelligent shading charging system, the descriptions also apply to controlling and/or communicating with multiple shading objects, intelligent umbrellas and/or intelligent charging systems.

In embodiments, an intelligent umbrella, comprising a shading expansion assembly, a support assembly, coupled to the shading expansion assembly, to provide support for the shading expansion assembly, a base assembly, coupled to the support assembly, to provide contact with a surface. In embodiments, the intelligent umbrella also comprises one or more wireless communication transceivers, one or more microphones to capture audible commands, one or more memory modules and one or more processors. In embodiments, computer-readable instructions stored in the one or more memory modules are executed by a processor to convert the captured audible commands into one or more audio files and perform noise reduction or noise cancellation on the one or more audio files to generate one or more noise-reduced audio files. In embodiments, the computer-readable instructions stored in the one or more memory modules are further executed by the one or more processors to communicate the one or more noise-reduced audio files to an external computing device utilizing the one or more wireless communication transceivers. In embodiments, the computer-readable instructions stored in the one or more memory modules are further executed by the one or more processors to perform voice recognition on the one or more noise-reduced audio files to generate audio command files. In embodiments, the computer-readable instructions stored in the one or more memory modules are further executed by the one or more processors to generate commands, signals or messages and communicate the commands, signals or messages to assemblies of the intelligent umbrella to perform actions based at least in part on the captured audible commands. In embodiments, performing noise reduction or noise cancellation on the one or more audio files to generate one or more noise-reduced audio files comprises reducing noise components of the one or more audio files captured by the one or more microphones by subtracting out components of previously stored noise audio files.

In embodiments, performing noise reduction or noise cancellation on the one or more audio files to generate noise-reduced audio files comprises sampling the one or more audio files captured by the one or more microphones to generate a plurality of command audio file samples and reducing the plurality of command audio file samples by subtracting associated noise file samples from the plurality from the plurality of command audio file samples to generate noise-reduced audio samples. In embodiments, the computer-readable instructions stored in the one or more memory modules are executed by the one or more processors further comprise capturing a current time or a current day of the week, retrieving a noise file associated a time or day that is closest to matching the captured current time or current day, and performing noise reduction on the captured one or more audio files utilizing the retrieved noise file to generate the one or more noise-reduced audio files. In embodiments, the computer-readable instructions stored in the one or more memory modules are executed by the one or more processors further to comprise parsing the one or more audio files into one or more noise command files and one or more umbrella command files, performing voice recognition on the one or more noise command files to determine names of corresponding noise files and performing noise reduction on the captured one or more audio files utilizing the retrieved noise files to generate the one or more noise-reduced audio files.

A mobile communications device includes one or more microphones, one or more processors, one or more memory modules, one or more wireless transceivers to communicate with an intelligent umbrella and computer-readable instructions stored in the one or more memory devices and executable by the one or more processors to capture noise files at a first time, via the one or more microphones, and generate first noise audio files for an environment in a vicinity the intelligent umbrella and capture noise files at a second time, via the one or more microphones, and generate second noise audio files for the environment surrounding the intelligent umbrella. In embodiments, computer-readable instructions stored in the one or more memory modules and executable by the one or more processors store the first noise audio files and the second noise audio files in the one or more memory modules, as baseline noise audio files for the environment in the vicinity of the intelligent umbrella. In embodiments, the computer-readable instructions stored in the one or more memory modules and executable by the one or more processors capture audible sounds via the one or more microphones, and generate one or more audio command files; and perform noise reduction processing on the one or more audio command files utilizing one of the first noise audio files or the second audio files to generate one or more noise-reduced audio command files. In embodiments, the computer-readable instructions stored in the one or more memory modules and executable by the one or more processors communicate the one or more noise-reduced audio command files, via the one or more wireless communications transceivers, to the intelligent umbrella for voice recognition processing. In embodiments, the computer-readable instructions stored in the one or more memory modules and executable by the one or more processors perform voice recognition on the one or more noise-reduced audio files to generate one or more command files. In embodiments, the computer-readable instructions stored in the one or more memory modules and executable by the one or more processors communicate the one or more command files to the intelligent umbrella to cause assemblies to act based at least in part on the audible commands. In embodiments, the computer-readable instructions stored in the one or more memory modules and executable by the one or more processor capture a first time identifier for the first noise audio file and a second time identifier for the second noise audio file; and store the first time identifier in a database record with the one or more first noise audio files and the second time identifier in a database record with the one or more second noise audio files. In embodiments, the computer-readable instructions stored in the one or more memory modules and executable by the one or more processors capture a current time identifier for a time subsequent to the first time identifier and the second time identifier; capture audible sounds via the one or more microphones, and generate one or more audio command files; retrieve one or more noise audio files from at least the first noise audio file or the second audio file, the one or more retrieved noise audio files having a noise identifier closest to the current noise identifier; and perform noise reduction processing on the one or more audio command files utilizing the retrieved noise audio files to generate one or more noise-reduced audio command files. In embodiments, the computer-readable instructions stored in the one or more memory modules and executable by the one or more processors capture a first type identifier for the first noise audio files and a second type identifier for the second noise audio files; and store the first type identifier in a database record with the first noise audio files and the second type identifier in a database record with the second noise audio files. In embodiments, the computer-readable instructions stored in the one or more memory modules and executable by the one or more processors capture a current noise type identifier for a time subsequent to the first type identifier and the second type identifier, capture audible sounds via the one or more microphones, and generate one or more audio command files; retrieve one or more noise audio files from at least the first noise audio files and the second audio files, the retrieved one or more noise audio files having a noise type identifier closest to the current noise type identifier; and perform noise reduction processing on the one or more audio command files utilizing the retrieved one or more noise audio files to generate one or more noise-reduced audio command files. In embodiments, the computer-readable instructions stored in the one or more memory modules and executable by the one or more processors sample the first noise audio files to generate first noise audio samples; and sample the second noise audio files to generate second noise audio samples; and store the first noise audio samples and the second noise audio samples. In embodiments, the first noise audio samples comprise a plurality of sample amplitudes and associated times or wavelength and the second noise audio samples comprise a plurality of sample amplitudes and associated times or wavelengths.

Still another embodiment involves a computer-readable medium comprising processor-executable instructions configured to implement one or more of the techniques presented herein. A computer-readable medium (e.g., a CD-R, DVD-R, or a platter of a hard disk drive), on which is encoded computer-readable data. This computer-readable data in turn comprises a set of computer instructions configured to operate according to one or more of the principles set forth herein. In one such embodiment, the processor-executable instructions may be configured to perform a method, such as described therein. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

The following discussion provide a brief, general description of a suitable computing environment to implement embodiments of one or more of the provisions set forth herein. The operating environment is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure

1. An intelligent umbrella, comprising:
a shading expansion assembly;
a support assembly, coupled to the shading expansion assembly, to provide support for the shading expansion assembly;
a base assembly, coupled to the support assembly, to provide contact with a surface;
one or more wireless communication transceivers;
one or more microphones to capture audible commands;
one or more memory modules;
one or more processors;
wherein computer-readable instructions stored in the one or more memory modules are executed by a processor to:
convert the captured audible commands into one or more audio files;
perform noise reduction or noise cancellation on the one or more audio files to generate one or more noise-reduced audio files.

2. The intelligent umbrella of claim 1, wherein the computer-readable instructions stored in the one or more memory modules are further executed by the one or more processors to:
communicate the one or more noise-reduced audio files to an external computing device utilizing the one or more wireless communication transceivers.

3. The intelligent umbrella of claim 1, wherein the computer-readable instructions stored in the one or more memory modules are further executed by the one or more processors to perform voice recognition on the one or more noise-reduced audio files to generate audio command files.

4. The intelligent umbrella of claim 3, wherein the computer-readable instructions stored in the one or more memory modules are further executed by the one or more processors to:
generate commands, signals or messages and communicate the commands, signals or messages to assemblies of the intelligent umbrella to perform actions based at least in part on the captured audible commands.

5. The intelligent umbrella of claim 1, wherein to perform noise reduction or noise cancellation on the one or more audio files to generate one or more noise-reduced audio files comprises:
reducing noise components of the one or more audio files captured by the one or more microphones by subtracting out components of previously stored noise audio files.

6. The intelligent umbrella of claim 1, wherein to perform noise reduction or noise cancellation on the one or more audio files to generate noise-reduced audio files comprises:
sampling the one or more audio files captured by the one or more microphones to generate a plurality of command audio file samples; and
reducing the plurality of command audio file samples by subtracting associated noise file samples from the plurality from the plurality of command audio file samples to generate noise-reduced audio samples.

7. The intelligent umbrella of claim 1, wherein the computer-readable instructions stored in the one or more memory modules are executed by the one or more processors further to comprise:
capturing a current time or a current day of the week;
retrieving a noise file associated a time or day that is closest to matching the captured current time or current day; and
performing noise reduction on the captured one or more audio files utilizing the retrieved noise file to generate the one or more noise-reduced audio files.

8. The intelligent umbrella of claim 1, wherein the computer-readable instructions stored in the one or more memory modules are executed by the one or more processors further to comprise:
parsing the one or more audio files into one or more noise command files and one or more umbrella command files;
performing voice recognition on the one or more noise command files to determine names of corresponding noise files;
performing noise reduction on the captured one or more audio files utilizing the retrieved noise files to generate the one or more noise-reduced audio files.

9. A mobile communications device, comprising:
one or more microphones;
one or more processors;
one or more memory modules;
one or more wireless transceivers to communicate with an intelligent umbrella; and
computer-readable instructions stored in the one or more memory devices and executable by the one or more processors to:
capture noise files at a first time, via the one or more microphones, and generate first noise audio files for an environment in a vicinity the intelligent umbrella; and
capture noise files at a second time, via the one or more microphones, and generate second noise audio files for the environment surrounding the intelligent umbrella.

10. The mobile communications device of claim 9, the computer-readable instructions stored in the one or more memory modules and executable by the one or more processors further to:
store the first noise audio files and the second noise audio files in the one or more memory modules, as baseline noise audio files for the environment in the vicinity of the intelligent umbrella.

11. The mobile communications device of claim 9, the computer-readable instructions stored in the one or more memory modules and executable by the one or more processors further to:
capture audible sounds via the one or more microphones, and generate one or more audio command files; and
perform noise reduction processing on the one or more audio command files utilizing one of the first noise audio files or the second audio files to generate one or more noise-reduced audio command files.

12. The mobile communications device of claim 11, the computer-readable instructions stored in the one or more memory modules and executable by the one or more processors further to:
communicate the one or more noise-reduced audio command files, via the one or more wireless communications transceivers, to the intelligent umbrella for voice recognition processing.

13. The mobile communications device of claim 11, the computer-readable instructions stored in the one or more memory modules and executable by the one or more processors further to:
perform voice recognition on the one or more noise-reduced audio files to generate one or more command files.

14. The mobile communications device of claim 13, the computer-readable instructions stored in the one or more memory modules and executable by the one or more processors further to:
communicate the one or more command files to the intelligent umbrella to cause assemblies to act based at least in part on the audible commands.

15. The mobile communications device of claim 10, the computer-readable instructions stored in the one or more memory modules and executable by the one or more processors further to:
capture a first time identifier for the first noise audio file and a second time identifier for the second noise audio file; and store the first time identifier in a database record with the one or more first noise audio files and the second time identifier in a database record with the one or more second noise audio files.

16. The mobile communications device of claim 15, the computer-readable instructions stored in the one or more memory modules and executable by the one or more processors further to:
capture a current time identifier for a time subsequent to the first time identifier and the second time identifier;
capture audible sounds via the one or more microphones, and generate one or more audio command files; and
retrieve one or more noise audio files from at least the first noise audio file or the second audio file, the one or more retrieved noise audio files having a noise identifier closest to the current noise identifier; and
perform noise reduction processing on the one or more audio command files utilizing the retrieved noise audio files to generate one or more noise-reduced audio command files.

17. The mobile communications device of claim 10, the computer-readable instructions stored in the one or more memory modules and executable by the one or more processors further to:
capture a first type identifier for the first noise audio files and a second type identifier for the second noise audio files; and store the first type identifier in a database record with the first noise audio files and the second type identifier in a database record with the second noise audio files.

18. The mobile communications device of claim 17, the computer-readable instructions stored in the one or more memory modules and executable by the one or more processors further to:
capture a current noise type identifier for a time subsequent to the first type identifier and the second type identifier;
capture audible sounds via the one or more microphones, and generate one or more audio command files; and
retrieve one or more noise audio files from at least the first noise audio files and the second audio files, the retrieved one or more noise audio files having a noise type identifier closest to the current noise type identifier; and
perform noise reduction processing on the one or more audio command files utilizing the retrieved one or more noise audio files to generate one or more noise-reduced audio command files.

19. The mobile communication device of claim 9, the computer-readable instructions stored in the one or more memory modules and executable by the one or more processors further to:
sample the first noise audio files to generate first noise audio samples; and
sample the second noise audio files to generate second noise audio samples; and store the first noise audio samples and the second noise audio samples.

20. The mobile communication device of claim 19, wherein the first noise audio samples comprise a plurality of sample amplitudes and associated times or wavelengths; and
wherein the second noise audio samples comprise a plurality of sample amplitudes and associated times or wavelengths.
